(19) United States
(12) Patent Application Publication
(10) Pub. No.: US 2006/0086015 A1
(43) Pub. Date: Apr. 27, 2006

(54) Pop-up calendar

(76) Inventors: Albert Zlotnick, Bala Cynwyd, PA (US); Ken Leyden, Huntingdon Valley, PA (US); John Miles Simon, Blue Bell, PA (US); Todd Treadway, Lakewood, CO (US); Len Epstein, Narberth, PA (US)

Correspondence Address: EZRA SUTTON, P.A., PLAZA 9, 900 ROUTE 9, WOODBRIDGE, NJ, 07095, US

(21) Appl. No.: 10/970,315

(22) Filed: Oct. 21, 2004

(51) Int. Cl. G09F 1/00

(52) U.S. Cl. 40/124.08

(57) ABSTRACT

A pop-up calendar display having one or more pop-up sports figures disposed therein. The pop-up calendar display card includes a cardboard blank member having a fold line for forming a base member and a vertical display member. The base member is for resting on a flat surface, and the vertical display member is for being vertically positioned on the flat surface relative to the fold line. The vertical display member and the base member each includes one or more pop-up display sections being partially cut out from the vertical display member and the base member. The vertical display member is movable between a first position, and a second display position. The pop-up display sections are movable between a first position, and a second display position. The base member is for supporting the pop-up calendar display, and having indicia thereon in the form of calendar information. The vertical display member is used for depicting a sporting event; and the pop-up display sections are in the form of one or more sports figures.

### FIELD OF THE INVENTION

The present invention relates to a pop-up calendar and sports figure formed from a cardboard blank. More particularly, the invention relates to a pop-up calendar that unfolds into a complex shape(s) as the calendar is opened to display sports figures.

### BACKGROUND OF THE INVENTION

Manual paper folding and cutout techniques (paper dolls, geometric shapes, butterflies and the like) are well known. More recently, there are foldout or pop-up books, especially for children, where a foldout/pop-up character is displayed on heavy paper stock within a given page of that story book. Also, there are pop-up greeting cards which have little flaps or doors that open to display a picture for the childs amusement.

There remains a need for a pop-up calendar having fold-out panels and pop-up figures depicting three-dimensional persons and backgrounds. One such depiction would include a promotional sports calendar having a major league baseball stadium background and pop-up sports figures.

### DESCRIPTION OF THE PRIOR ART

Three-dimensional cards, pop-up cards, three paneled structures (triptych construction) and other polygon configurations for books, cards, calendars and the like having various, designs, structures, configurations and materials of construction have been disclosed in the prior art. For example, U.S. Pat. No. 5,259,133 to BURTCH discloses a pop-up display device that is erectable to provide, for example, a pop-up action figure as part of a baseball card or the like. The device comprises a flat base portion forming a support for the device and an erectable display portion disposed in a non-erected state so as to overlie the base portion and including a pop-up portion partially cut out from the erectable display portion adjacent to a central transverse fold line therein. Disposed between the erectable display portion and the base portion is a pull tab member which includes a pull tab located at one end thereof and which is secured to the erectable display portion such that a pulling force exerted on the pull tab will cause the erectable display portion to elevate from the plane of the base portion at the fold line and to thereby cause the pop-up portion to be erected so as to extend outwardly from the remainder of the erectable display portion at the fold line. This prior art patent does not disclose or teach the particular structure and design of the pop-up calendar of the present invention.

U.S. Pat. No. 5,979,090 to LEE et al. discloses a triptych construction suitable as a calendar or three-dimensional stage structure. The triptych construction is made from a single cardboard blank. The construction comprises a main display panel having a front face with an image depicted on it. Also provided is a pair of side door panels, each foldably connected to the main panel along opposite side edges. Each side panel is foldably displaceable between a first open outwardly extending position such that the image on the front face of the main panel is fully visible, and a second inwardly extending position for substantially covering up the image on the front face from view. This prior art patent does not disclose or teach the particular structure and design of the pop-up calendar of the present invention.

U.S. Pat. No. 6,311,142 to GLASSNER discloses a method for the design and placement of tiered geometrical objects such as objects used in pop-up card designs. This method of pop-up card designs allows for computerized modeling and enforcement of design constraints. Graphics can be associated with the card parts and such graphics are automatically adjusted for proper viewing of the image in perspective on a particular card piece. This prior patent does not disclose or teach the particular structure and design of the pop-up calendar of the present invention.

None of the aforementioned prior art patents disclose the particular design and structure of a pop-up sports calendar depicting three-dimensional persons and backgrounds.

Accordingly, it is an object of the present invention to provide a pop-up sports calendar having one or more three-dimensional pop-up sports figures and/or coaches on a playing field at given sports stadium. For example, a major league baseball stadium background having one or more pop-up sports figures and a league calendar of the home and away games played by the team.

Another object of the present invention is to provide a pop-up sports calendar for other sport teams that include football, basketball, hockey, soccer, tennis, horse racing, sailing, car/drag racing and the like.

Another object of the present invention is to provide a pop-up sports calendar for professional sport teams; amateur sport teams such as “Little League Baseball”, “Pop-Warner Football”, school/club ice hockey teams, high school sport teams, charity sporting events and the like; and individualized and personalized sporting events such as golf, tennis, fishing, billiards, boxing, depicting either professional, amateur, or family members at that sporting event.

Another object of the present invention is to provide a pop-up sports calendar that is durable, easy to use and is non-breakable.

A still further object of the present invention is to provide a pop-up sports calendar that can be mass produced in an automated and economical manner and is readily affordable by the sports enthusiast/user.

### SUMMARY OF THE INVENTION

In accordance with the present invention, there is provided a pop-up calendar display having one or more pop-up sports figures disposed therein. The pop-up calendar display includes a cardboard blank member having a fold line for forming a base member and a vertical display member. The base member is for resting on a flat surface, and the vertical display member is for being vertically positioned on the flat surface relative to the fold line. The vertical display member and the base member each includes one or more pop-up display sections being partially cut out from the vertical display member and the base member; and the pop-up display sections having a second fold line in the base member thereof for forming a pop-up calendar display card. The vertical display member is movable between a first position, wherein the vertical display member lies in a flat position parallel to the base member and a second position wherein the vertical display member is substantially perpendicular to the base member. The pop-up display sections are movable between a first position, wherein the pop-up display sections on the vertical display member lie in a flat position parallel to the base member, and a second position wherein the pop-up display sections on the vertical display member and the base member are substantially perpendicular to the base member. The base member is for supporting of the pop-up calendar display card, and having indicia thereon in the form of calendar information. The vertical display member is used for depicting a sporting event; and the pop-up display sections are in the form of one or more sports figures.

### BRIEF DESCRIPTION OF DRAWINGS

Further objects, features and advantages of the present invention will become apparent upon the consideration of the following detailed description of the presently preferred embodiment when taken in conjunction with the accompanying drawings, wherein:

FIG. 1 is a top plan view of the pop-up calendar display of the preferred embodiment of the present invention showing the major component parts as layed out on a cardboard blank;

FIG. 2 is a front perspective view of the pop-up calendar display of the present invention showing a closed configuration of the calendar display card;

FIG. 3 is a front perspective view of the pop-up calendar display of the present invention showing an opened and expanded configuration of the calendar display having a pair of pop-up display sections in the form of basketball players;

FIG. 4 is a front perspective view of the pop-up calendar display of the present invention showing an opened and expanded configuration of the calendar display having multiple pop-up display sections in the form of football players;

FIG. 5 is a front perspective view of the pop-up calendar display of the present invention showing a vertical display member, a base member and a pop-up display section in the form of a race car and driver in an opened and expanded configuration; and

FIG. 6 is a front perspective view of the pop-up calendar display of the present invention showing the vertical display member, the base member and a pair of pop-up display sections in the form of sailboats in an opened and expanded configuration.

### DETAILED DESCRIPTION OF THE PREFERRED EMBODIMENT

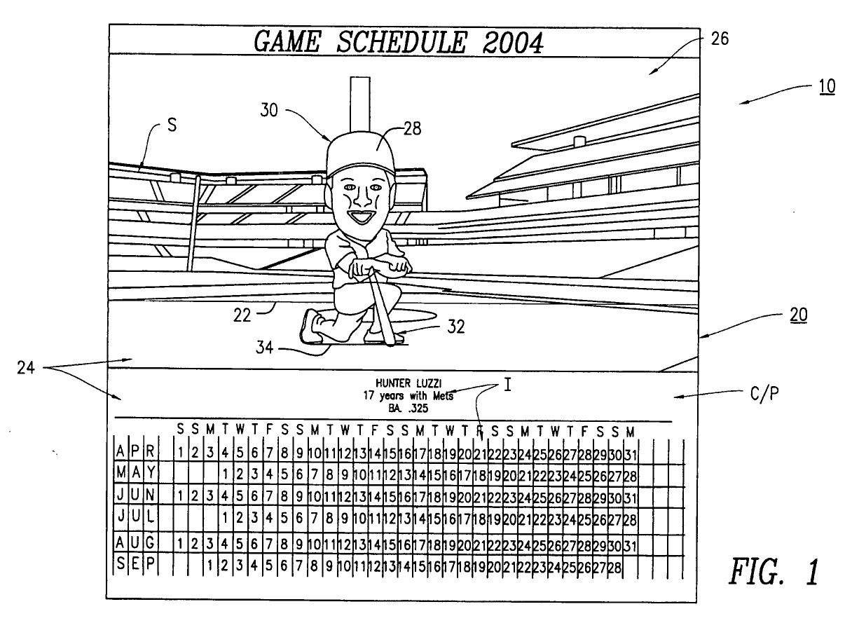

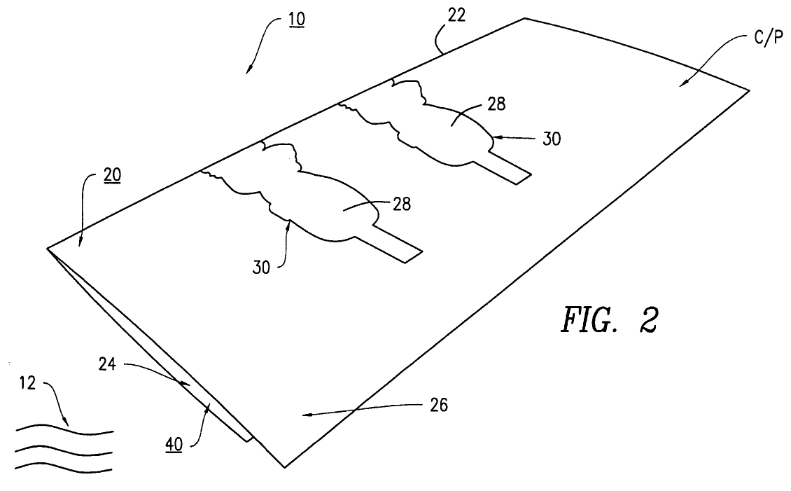

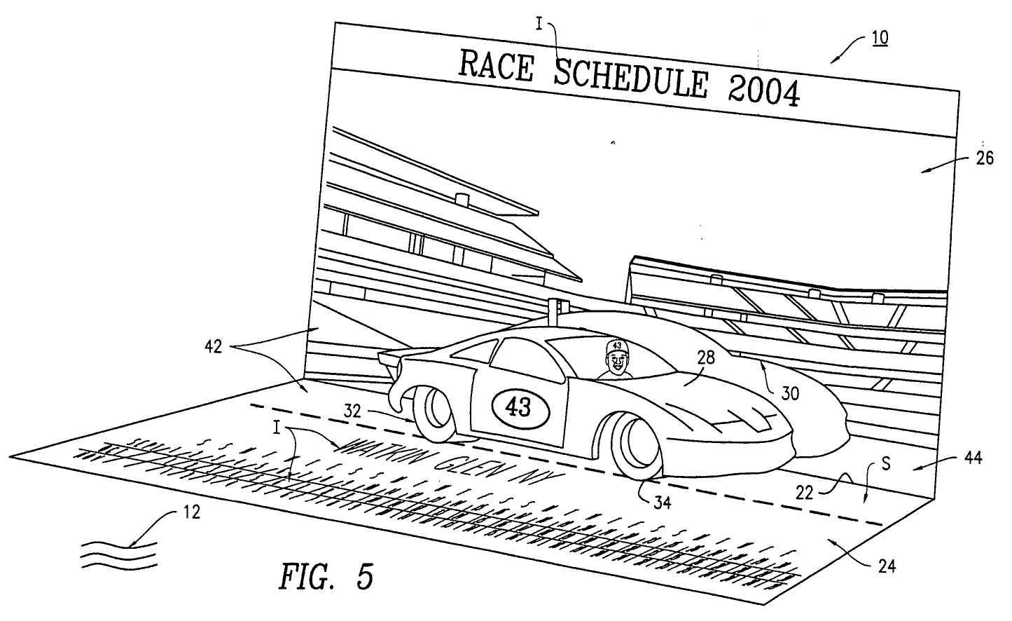

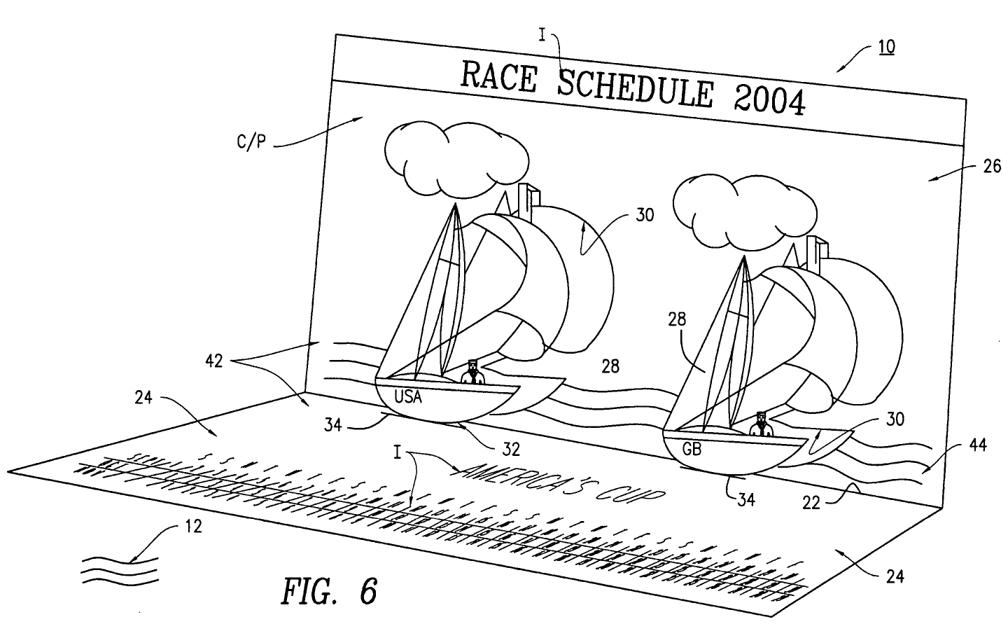

The pop-up calendar display 10 and its component parts of the preferred embodiment of the present invention are represented in detail by FIG. 1 through 8 of the patent drawings. The pop-up calendar display 10, as shown in FIGS. 1 and 2, includes a cardboard blank member 20 having a fold line 22 for forming a base member 24 and a vertical display member 26. The base member 24 is used for resting on a flat surface 12, and the vertical display member 26 is vertically positioned on the flat surface 12 relative to the fold line 22. The cardboard blank member 20 is made from heavy duty card stock C or made from foldable plastic material P.

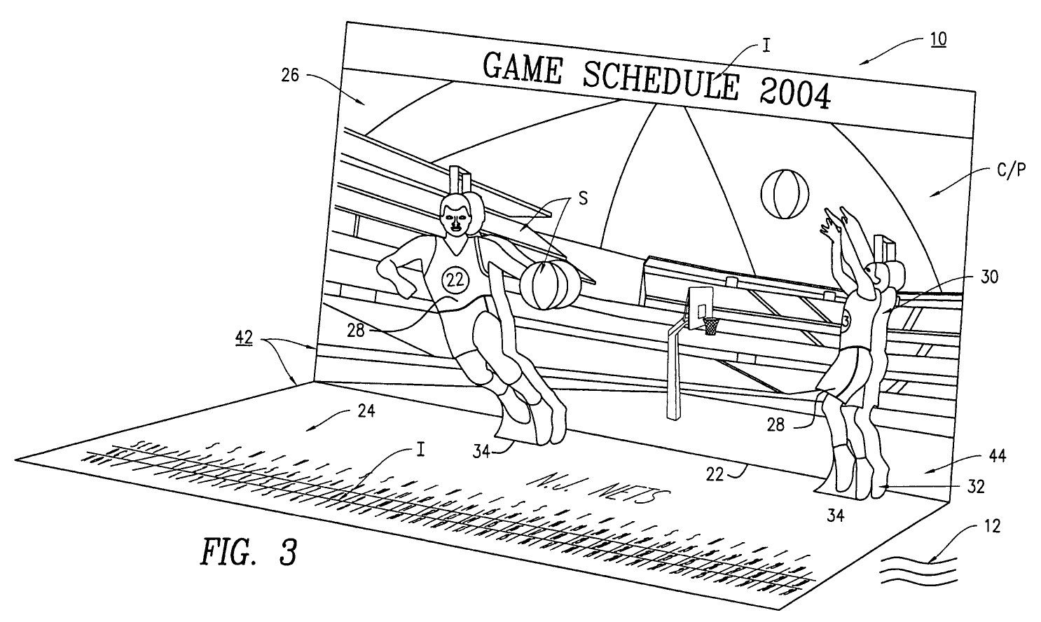

The vertical display member 26 and the base member 24 each include one or more pop-up display sections 28 being partially cut out 30 and 32 from the vertical display member 26 and the base member 24, respectively, as depicted in FIGS. 2 through 5 of the patent drawings. Further, each of the one or more pop-up display sections 28 include a second fold line 34 being positioned in the base member 24 thereof for forming the pop-up calendar display 10, as shown FIGS. 2 and 3. The pop-up display sections 28 are in the form of a professional athlete, an amateur athlete, a coach, a non-athlete, or a family member such as a parent, a child, siblings and the like for a given sporting event. The pop-up display sections 28 can also be in the form of an animal (a race horse), a fish (a sword fish, a shark), a vehicle (a race car), a water craft (a sail boat/power boat), athletic equipment (a football helmet) and other inanimate objects being used in a sporting event.

The vertical display member 26 is used for depicting a sporting event S, wherein the sporting event S includes football, baseball, soccer, basketball, hockey, tennis, horse racing, sailing, power boating, car/drag racing, golf, fishing, hunting, boxing, billiards/pool, karate, fencing and other sports. The vertical display member 26 can further include a pictorial representation of a sports stadium, a playing field, a race track (ie., car or horse track), an outdoors scene (i.e., showing a river, a ocean, a forest for fishing, sailing or hunting, respectively, etc.) for depicting of the aforementioned sporting events S, as shown in FIGS. 1 through 5 of the drawings.

The base member 24 is used for supporting the vertical display member 26 of the pop-up calendar display 10. The base member 24 includes indicia 14 in the form of calendar or general information I, wherein the calendar and/or general information includes home and away game information, weekly sports dates and locations, monthly calendar events for the season, team information, sports figure biographical information and the like.

### OPERATION OF THE PRESENT INVENTION

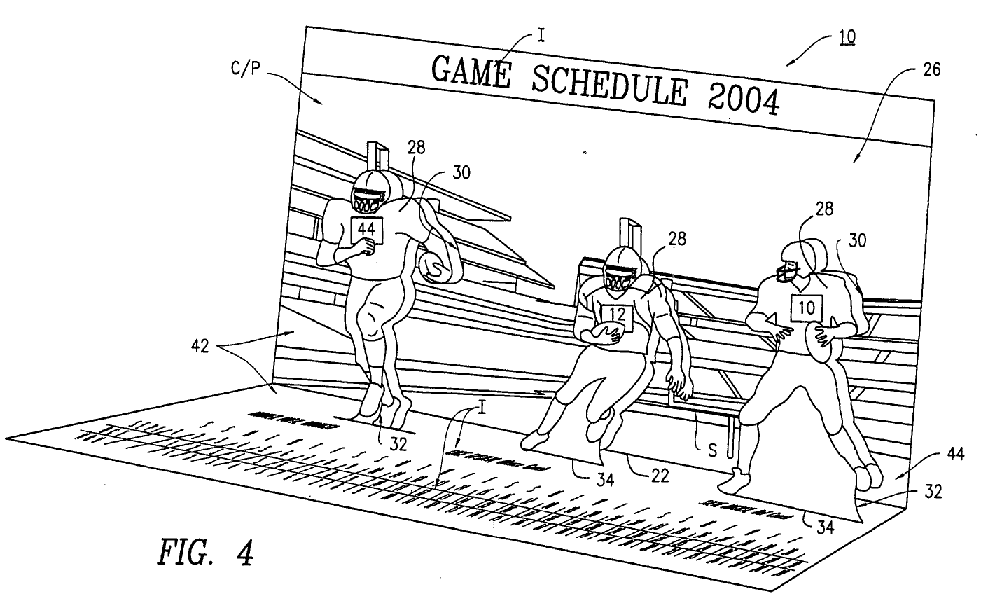

In operation, as depicted in FIGS. 1 through 6 of the drawings the pop-up calendar display 10 operates in the following manner. The vertical display member 26 is movable between a first position 40, wherein the vertical member 26 lies in a flat position parallel to the base member 24, and a second position (open position) 42 wherein the vertical display member 26 is substantially perpendicular 44 to the base member 24. Further, the pop-up display sections 28 are movable between a first position 40, wherein the pop-up display sections 28 and the vertical display member 26 lie in a flat position parallel to the base member 24 (See FIG. 2), and a second position 42 wherein the pop-up display sections 28 and vertical display member 26 are substantially perpendicular 44 (See FIGS. 3 and 4) to the base member 24. Thus, as the pop-up calendar display 10 is opened-up by the user, the one or more pop-up display sections 28 automatically “pop-out” from their original positions within the vertical display member 26 and base member 24, respectively, as shown in FIGS. 3 to 5 of the drawings.

In the preferred embodiment, pop-up display sections 28 are in the form of sports figures, and members 24 and 26 have at work to form a background, such as a baseball stadium, for the sports figures. Members 24 and 26 may also include information for a calendar.

### ADVANTAGES OF THE PRESENT INVENTION

Accordingly, an advantage of the present invention is that it provides for a pop-up sports calendar having one or more three-dimensional pop-up sports figures and/or coaches on a playing field at given sports stadium. For example, a major league baseball stadium background having one or more pop-up sports figures and a league calendar of the home and away games played by the team.

Another advantage of the present invention is that it provides for a pop-up sports calendar for other sport teams that include football, basketball, hockey, soccer, tennis, horse racing, sailing, car/drag racing and the like.

Another advantage of the present invention is that it provides for a pop-up sports calendar for professional sport teams; amateur sport teams such as “Little League Baseball”, “Pop-Warner Football”, school/club ice hockey teams, high school sport teams, charity sporting events and the like; and individualized and personalized sporting events such as golf, tennis, fishing, billiards, boxing, depicting either professional, amateur, or family members at that sporting event.

Another advantage of the present invention is that it provides for a pop-up sports calendar that is durable, easy to use and is non-breakable.

Still a further advantage of the present invention is that it provides for a pop-up sports calendar that can be mass produced in an automated and economical manner and is readily affordable by the sports enthusiast/user.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

1. A pop-up calendar display having one or more pop-up sports figures disposed therein, comprising:
a) a cardboard blank member having a first fold line for forming a horizontal base member and a vertical display member movable relative to each other about said first fold line;
b) said horizontal base member for resting on a flat surface, and said vertical display member for being vertically positioned relative to said flat surface and relative to said first fold line;
c) said vertical display member and said horizontal base member each including one or more pop-up display sections which cooperate to form one or more sports figures, wherein a first pop-up display section is partially cut out from said vertical display member and wherein a second pop-up display section is partially cut out from said horizontal base member; wherein said first and second pop-up display sections are connected to each other and cooperate to form a 3-dimensional sports figure; said pop-up display sections having a second fold line in said base member thereof for forming a pop-up calendar display;
d) said vertical display member being movable between a first position, wherein said vertical display member lies in a flat position parallel to said horizontal base member and a second position wherein said vertical display member is substantially perpendicular to said horizontal base member;
e) said first and second pop-up display sections being movable between a first position, wherein said first pop-up display sections on said vertical display member lie in a flat horizontal position parallel to said horizontal base member, and a second display position wherein said first pop-up display sections on said vertical display member and said second pop-up display sections on said horizontal base member are substantially perpendicular to said horizontal base member;
f) said horizontal base member for supporting said pop-up calendar display, and having indicia thereon in the form of calendar information;
g) said vertical display member for depicting a sporting event; and
h) said first and second pop-up display sections in said vertical display member and in said horizontal base member are connected to each other and cooperate to form one or more 3-dimensional sports figures for the purpose of entertaining and informing the user about sports when said vertical display member is moved to said second position.

2. A pop-up calendar display in accordance with claim 1, wherein said cardboard blank member is made from heavy duty card stock.

3. A pop-up calendar display in accordance with claim 1, wherein said cardboard blank member is made from foldable plastic material.

4. A pop-up calendar display in accordance with claim 1, wherein said sporting event is selected from the group consisting of football, baseball, soccer, basketball, hockey, tennis, horse racing, sailing, car/drag racing, golf, fishing, boxing, billiards, hunting, karate, fencing and other sports.

5. A pop-up calendar display in accordance with claim 1, wherein said pop-up display section of one or more sports figures are selected from the group consisting of professional athlete, an amateur athlete, a coach, a non-athlete, a family member representing a team and an individual in such a sporting event.

6. A pop-up calendar display in accordance with claim 1, wherein said pop-up display section is in the form of a backdrop selected from the group consisting of an animal, a fish, a vehicle, a water craft, and athletic equipment.

7. A pop-up calendar display in accordance with claim 4, wherein said vertical display member is in the form of a pictorial representation selected from the group consisting of a sports stadium, a playing field, a race track, and an outdoors scene for depicting said sporting event.

8. A pop-up calendar display in accordance with claim 1, wherein said calendar information on said base member is selected from the group consisting of home and away game information, weekly sports dates and locations, and monthly calendar dates.

9. A pop-up calendar display in accordance with claim 1, wherein said base member having said indicia thereon further includes general information in the form of team information, and sports figure biographical information.
